(19) United States
(12) Patent Application Publication
(10) Pub. No.: US 2007/0041443 A1
(43) Pub. Date: Feb. 22, 2007

(54) Method and apparatus for encoding multiview video

(75) Inventors: Tae-hyeun Ha, Suwon-si (KR); Pil-ho Yu, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/497,255

(22) Filed: Aug. 2, 2006

Related U.S. Application Data
(60) Provisional application No. 60/709,811, filed on Aug. 22, 2005.

(30) Foreign Application Priority Data
Nov. 5, 2005 (KR) 10-2005-0105728

(51) Int. Cl. H04N 11/04; H04N 7/12

(52) U.S. Cl. 375/240.15; 375/240.26

(57) ABSTRACT

A method and an apparatus for encoding a multiview video using a minimum amount of information regarding the multiview video are provided. The method includes: categorizing a plurality of B frames into at least two groups according to a predetermined standard; and sequentially encoding the categorized B frames. Therefore, a multiview video which is realistic can be simultaneously provided to many people using a minimum amount of information regarding the multiview video.

This application claims priority from U.S. Provisional Application 60/709,811, filed on Aug. 22, 2005 and Korean Patent Application No. 10-2005-0105728, filed on Nov. 5, 2005, in the Korean Intellectual Property Office, the disclosures of which are incorporated herein in their entirety by reference.

### BACKGROUND OF THE INVENTION

1. Field of the Invention

Methods and apparatuses consistent with the present invention relate to encoding a multiview video sequence, and more particularly, to encoding a multiview video photographed by a multiview camera using a minimum amount of information regarding the multiview video.

2. Description of the Related Art

Realism is an important factor in realizing high-quality information and telecommunication services. This realism can be achieved with video communication based on three-dimensional (3D) images. 3D imaging systems have many potential applications in education, entertainment, medical surgery, videoconferencing, and the like. To provide many viewers with more vivid and accurate information of a remote scene, three or more cameras are placed at slightly different viewpoints to produce a multiview sequence.

Reflecting the current interest in 3D images, a number of research groups have developed 3D-image processing and display systems. In Europe, research on 3DTV has been initiated through several projects such as DISTIMA, the objective of which is to develop a system for capturing, coding, transmitting and displaying digital stereoscopic image sequences. These projects have led to another project, PANORAMA, with the goal of enhancing visual information in 3D telepresence communication. The projects have also led to another project, ATTEST, in which various technologies for 3D-content acquisition, 3D-compression & transmission, and 3D-display systems were researched. In the ATTEST project, motion picture experts group 2 (MPEG-2) and digital video broadcasting (DVB) standards were applied to transmit 3D contents using temporal scalability. To achieve temporal scalability, a base layer is used for the transmission of 2D contents and an advanced layer is used for the transmission of 3D contents.

The MPEG-2 standard was amended in 1996 to define a multiview profile (MVP). The MVP defines the usage of a temporal scalability mode for multi-camera sequences and acquisition camera parameters in an MPEG-2 syntax.

A base-layer stream which represents a multiview video signal can be encoded at a reduced frame rate, and an enhancement-layer stream, which can be used to insert additional frames in between, can be defined to allow reproduction at a full frame rate when both streams are available. A very efficient way to encode the enhancement layer is to determine the optimal method of performing motion-compensated estimation on each macroblock in an enhancement layer frame based on either a base layer frame or a recently reconstructed enhancement layer frame.

The process of stereo and multiview channel encoding such a multiview video signal using temporal scalability syntax is straightforward. For this purpose, a frame from a particular camera view (usually a left-eye frame) is defined as the base layer, and a frame from the other camera view is defined as the enhancement layer. The base layer represents a simultaneous monoscopic sequence. For the enhancement layer, although disparity-compensated estimation may fail in occluded regions, it is still possible to maintain the quality of a reconstructed image using motion-compensated estimation within the same channel. Since the MPEG-2 MVP was mainly defined for stereo sequences, it does not support multiview sequences and is inherently difficult to extend to multiview sequences.

FIG. 1 is a block diagram of a conventional encoder and decoder of the MPEG-2 MVP. The scalability provided by the MPEG-2 is used to simultaneously decode images having different resolutions or formats with an image-processing device. Among scalabilities supported by MPEG-2, temporal scalability is used to improve visual quality by increasing a frame rate. The MVP is applied to stereo sequences in consideration of temporal scalability.

The encoder and decoder illustrated in FIG. 1 are a stereo video encoder and decoder with temporal scalability. Left images in a stereo video are input to a base view encoder, and right images are input to a temporal auxiliary view encoder.

The temporal auxiliary view encoder provides temporal scalability, and is an interlayer encoder interleaving images between images of the base layer.

When the left image is separately encoded and decoded, a two-dimensional (2D) video can be obtained. When the left image and the right image are simultaneously encoded and decoded, a stereoscopic video can be obtained. To transmit or store a video, a system multiplexer and a system demultiplexer are needed to combine or separate sequences of the two images.

FIG. 2 is a block diagram of a conventional stereo-video encoder and decoder using the MPEG-2 MVP.

An image of the base layer is encoded through motion compensation and discrete cosine transform (DCT). The encoded image is decoded in a reverse process. A temporal auxiliary view encoder functions as a temporal interlayer encoder which performs prediction based on the decoded image of the base layer.

In other words, disparity compensated estimation may be performed twice, or disparity estimation and motion compensated estimation may each be performed once. Like an encoder and decoder of a base layer, the temporal auxiliary view encoder includes a disparity and motion compensated DCT encoder and decoder.

Further, a disparity compensated encoding process requires a disparity estimator and a compensator as a motion estimation/compensation encoding process requires a motion estimator and compensator. In addition to block-based motion/disparity estimation and compensation, the encoding process includes performing DCT on a difference between an estimated image and an original image, quantization of DCT coefficients, and variable length encoding. On the other hand, a decoding process includes variable length decoding, inverse quantization and inverse DCT.

MPEG-2 encoding is a very effective compression method because bi-directional motion estimation is performed for bi-directionally motion-compensated pictures (B pictures). Since the MPEG-2 encoding provides highly effective temporal scalability, B pictures can be used to encode a right image sequence. Consequently, a highly compressed right sequence can be generated.

FIG. 3 illustrates disparity-based predictive encoding in which disparity estimation is used twice for bi-directional motion estimation.

A left image is encoded using a non-scalable MPEG-2 encoder, and a right image is encoded using a MPEG-2 temporal auxiliary view encoder based on the decoded left image.

In other words, a right image is predicted using two reference images, e.g., two left images, and encoded into a B picture. In this case, one of the two reference images is an isochronal left image to be simultaneously displayed with the right image, and the other is a left image that follows the isochronal left image.

Like the motion estimation/compensation, the two predictions have three prediction modes: a forward mode, a backward mode and an interpolated mode. The forward mode denotes disparity estimation based on the isochional left image, and the backward mode denotes disparity estimation based on the left image that immediately follows the isochronal left image. In this case, a right image is predicted using disparity vectors of the two left images. Such an estimation method is called predictive encoding, considering only disparity vectors. Therefore, an encoder estimates two disparity vectors for each frame of a right image, and a decoder decodes the right image from the left image using the two disparity vectors.

FIG. 4 illustrates predictive encoding using a disparity vector and a motion vector for the bi-directional estimation. In the predictive encoding illustrated in FIG. 4, B pictures obtained through the bi-directional estimation of FIG. 3 are used. However, disparity estimation and motion estimation are each used once in the bi-directional estimation. That is, the disparity estimation using an isochronal left image and the motion estimation using a previous right image are used.

Further, the bidirectional estimation also includes three estimation modes, i.e., a forward mode, a backward mode and an interpolated mode, as in the disparity-based predictive encoding of FIG. 3. The forward mode denotes motion estimation based on a decoded right image, and the backward mode denotes disparity estimation based on a decoded left image.

As described above, since the MPEG-2 MVP does not consider a multiview video encoder, it is not suitable for encoding a multiview video. Therefore, a multiview video encoder for simultaneously providing a multiview video, which is stereoscopic and realistic, to many people is required.

### SUMMARY OF THE INVENTION

The present invention provides a method and apparatus for efficiently encoding a multiview video which is realistic and simultaneously providing the encoded multiview video to many people.

The present invention also provides a method and apparatus for encoding a multiview video using a prediction structure that uses a minimum amount of information regarding the multiview video.

According to an aspect of the present invention, there is provided a method of encoding a multiview video, the method including: categorizing a plurality of B frames into at least two groups according to a predetermined standard; and sequentially encoding the categorized B frames.

The predetermined standard may be the number of frames to which each B frame refers. Alternatively, the predetermined standard may be the number of reference frames to which each B frame refers and positions of the reference frames.

The B frames may be categorized into a first group of B frames which are predicted with reference to two horizontally adjacent frames, two vertically adjacent frames or one horizontally adjacent frame and one vertically adjacent frame, a second group of B frames which are predicted with reference to two horizontally adjacent frames and one vertically adjacent frame or one horizontally adjacent frame and two vertically adjacent frames, and a third group of B frames which are predicted with reference to two horizontally adjacent frames and two vertically adjacent frames, wherein the one or two horizontally adjacent frames are a frame or frames obtained from the multiview video at a same temporal level as a referring B frame, and the one or two vertically adjacent frames are a frame or frames obtained from the multiview video at a same view position as a referring B frame.

The sequential encoding of the categorized B frames may include sequentially encoding the first group of B frames, the second group of B frames, and the third group of B frames.

The sequential encoding may be performed based on a video encoding structure which includes the B frames, and may further include performing disparity estimation between frames disposed horizontally according to a plurality of views and performing motion estimation between frames disposed vertically according to the passage of time, and the video encoding structure can be horizontally and vertically extended.

In the video-encoding structure which includes the B frames, a video encoding structure having n views can be configured into a video encoding structure having n-1 views by disabling an (n-1)th column of frames, wherein n is an odd natural number.

According to another aspect of the present invention, there is provided an apparatus for encoding a multiview video, the apparatus including: a prediction unit which predicts a disparity vector and a motion vector of an input multiview video; a disparity and motion compensation unit which compensates an image using the predicted disparity vector and motion vector; a residual image encoding unit which receives an original image and the compensated image generated by the disparity and motion compensation unit, subtracts the compensated image from the original image, and encodes a residual image obtained from the subtraction; and an entropy-encoding unit which generates a bit stream for the multiview video using the disparity vector, the motion vector, and the encoded residual image, wherein the prediction unit categorizes a plurality of B frames into at least two groups according to a predetermined standard and sequentially predicts the categorized B frames.

According to another aspect of the present invention, there is provided a computer-readable recording medium on which a program for executing a program for implementing the method is recorded.

### BRIEF DESCRIPTION OF THE DRAWINGS

The above and other features and advantages of the present invention will become more apparent by describing in detail exemplary embodiments thereof with reference to the attached drawings, in which:

FIG. 1 is a block diagram of a related art encoder and decoder of a motion picture experts group 2 (MPEG-2) multiview profile (MVP);

FIG. 2 is a block diagram of a related art stereo-video encoder and decoder using the MPEG-2 MVP;

FIG. 3 illustrates a related art disparity-based predictive encoding in which disparity estimation is used twice for bi-directional motion estimation;

FIG. 4 illustrates a related art predictive encoding using a disparity vector and a motion vector for the bi-directional estimation;

FIG. 5 is a block diagram of an apparatus for encoding a multiview video according to an exemplary embodiment of the present invention;

FIG. 6 illustrates a unit encoding structure of a multiview video according to an exemplary embodiment of the present invention;

FIGS. 7A through 7F illustrate three types of B pictures used in multiview video encoding according to an exemplary embodiment of the present invention;

FIG. 8 illustrates a horizontally extended unit encoding structure of a multiview video according to an exemplary embodiment of the present invention;

FIG. 9 illustrates a prediction sequence of the multiview image of FIG. 8;

FIG. 10 illustrates a video encoding structure having an odd number of views for motion estimation and disparity estimation according to an exemplary embodiment of the present invention;

FIG. 11 illustrates a video encoding structure having an even number of views for motion estimation and disparity estimation according to an exemplary embodiment of the present invention; and

FIG. 12 is a flowchart illustrating a method of encoding a multiview video according to an exemplary embodiment of the present invention.

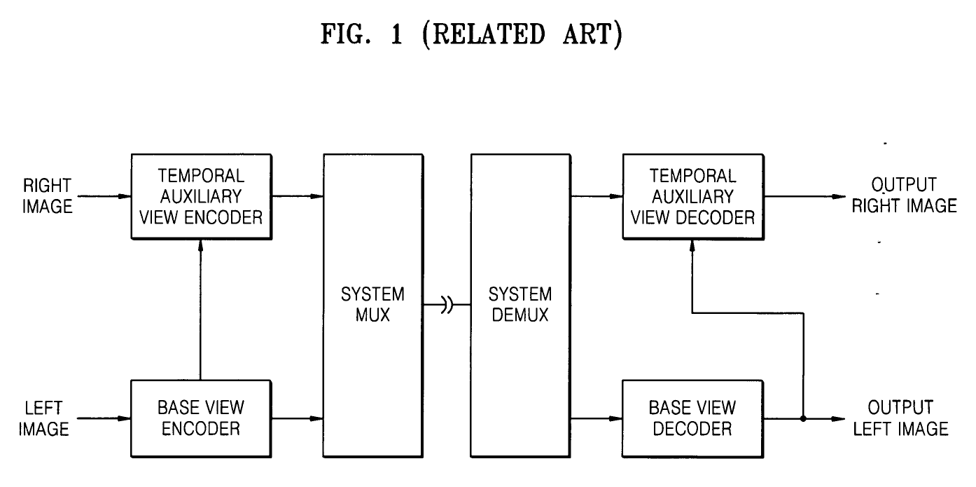

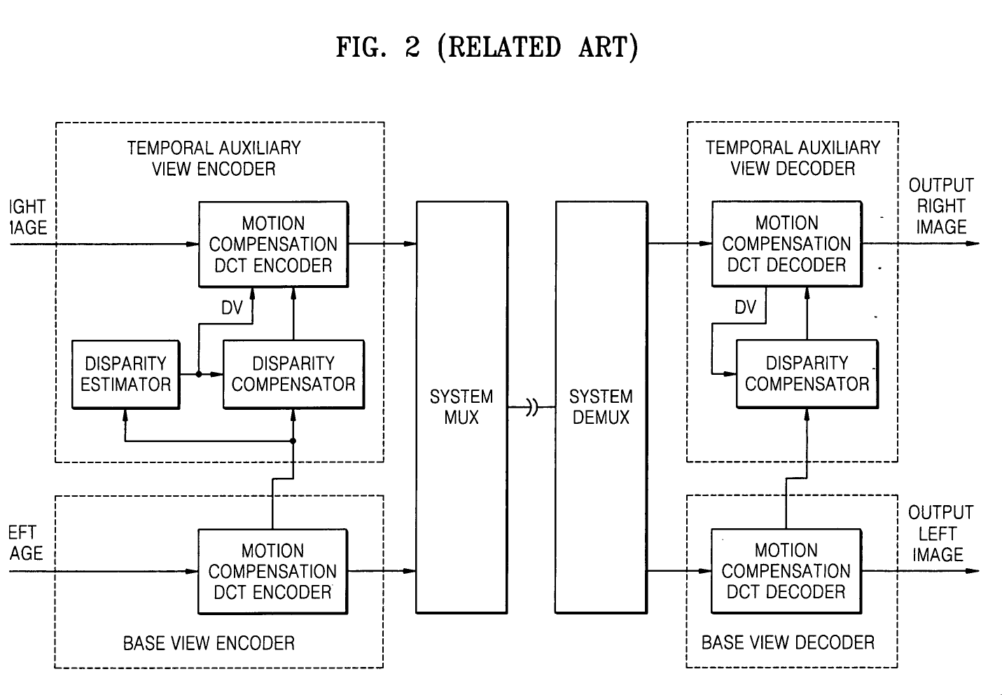

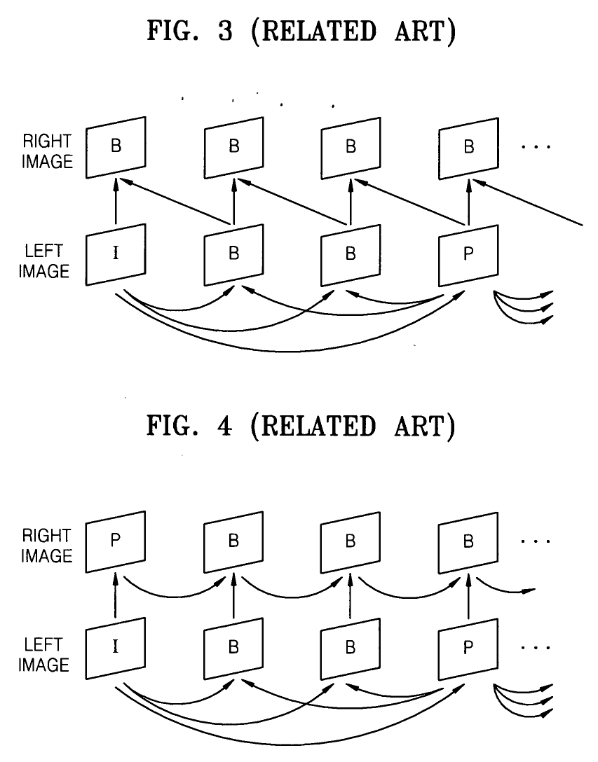

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth therein; rather, these embodiments are provided so that this disclosure will be thorough and complete, and will fully convey the concept of the invention to those skilled in the art.

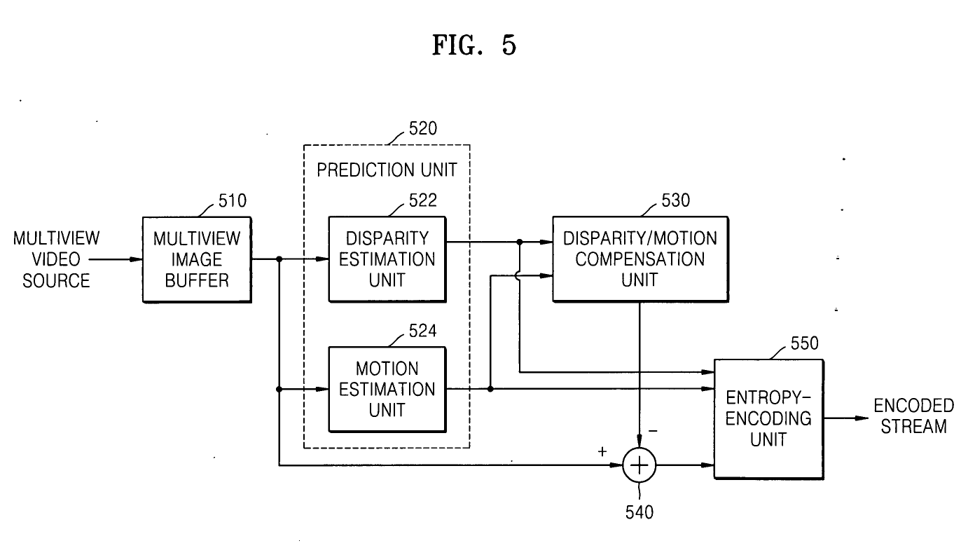

FIG. 5 is a block diagram of an apparatus for encoding a multiview video according to an exemplary embodiment of the present invention.

Referring to FIG. 5, the apparatus includes a multiview image buffer 510, a prediction unit 520, a disparity/motion compensation unit 530, a residual image encoding unit 540, and an entropy-encoding unit 550.

The apparatus can receive a multiview video source from a plurality of camera systems or through another method. The received multiview video is stored in the multiview image buffer 510. The multiview image buffer 510 provides the multiview video to the prediction unit 520 and the residual image encoding unit 540.

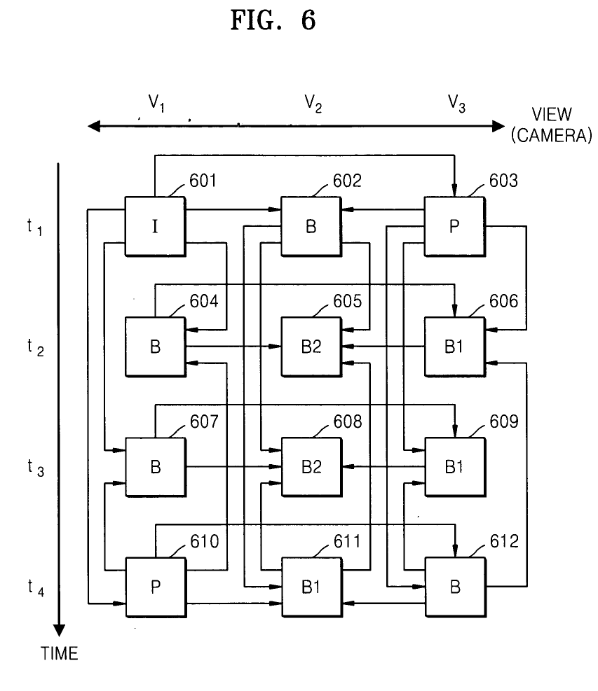

The prediction unit 520 includes a disparity estimation unit 522 and a motion estimation unit 524. The prediction unit 520 performs motion estimation and disparity estimation on the multiview video. The prediction unit 520 estimates a disparity vector and a motion vector in directions indicated by arrows illustrated in FIGS. 6 through 11, and provides the estimated disparity vector and the motion vector to the disparity/motion compensation unit 530.

As illustrated in multiview video encoding structures illustrated in FIGS. 6 through 11, the prediction unit 520 may set directions for performing motion estimation and disparity estimation by efficiently using a multiview disparity vector and a motion vector which are generated when the multiview video source is extended based on a time axis. In other words, an MPEG-2 encoding structure can be extended based on a view axis to use spatial/temporal correlation of the multiview video.

The disparity/motion compensation unit 530 performs the disparity estimation and the motion estimation using the motion vector and the disparity vector estimated by the disparity estimation unit 522 and the motion estimation unit 524. The disparity/motion compensation unit 530 reconstructs an image using the estimated motion vector and disparity vector and provides the reconstructed image to the residual image encoding unit 540.

To provide better visual quality and stereoscopy, the residual image encoding unit 540 encodes a residual image obtained by subtracting the image compensated and reconstructed by the disparity/motion compensation unit 530 from the original image provided by the multiview image buffer 510 and provides the encoded residual image to the entropy-encoding unit 550.

The entropy-encoding unit 550 receives the estimated disparity vector and motion vector from the prediction unit 520 and the encoded residual image from the residual image encoding unit 540 and generates a bit stream for the multiview video source.

FIG. 6 illustrates a unit encoding structure of a multiview video according to an exemplary embodiment of the present invention. A core-prediction structure or a unit-prediction structure illustrated in FIG. 6 is based on the assumption that there are three views. A square block indicates an image frame in a multiview video. A horizontal arrow indicates a sequence of frames according to views or positions of cameras, and a vertical arrow indicates a sequence of the frames according to time. An I picture indicates an “intra picture”, identical to an I frame in MPEG-2/4 or H.264. P and B pictures respectively indicate a “predictive picture” and a “bidirectional prediction picture”, similar to P and B frames in MPEG-2.4 or H.264.

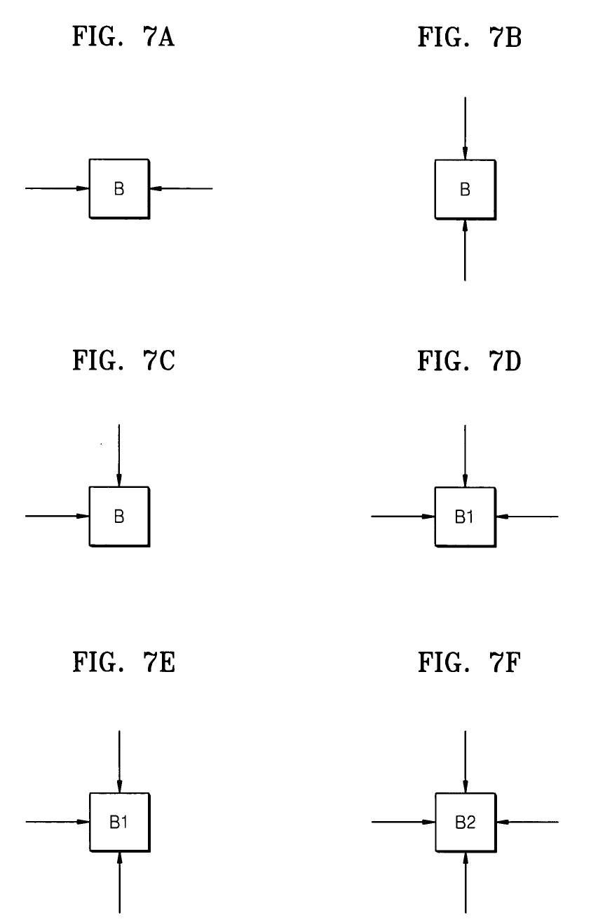

The P and B pictures are estimated by the motion estimation and the disparity estimation together in the multiview video coding. In FIG. 6, arrows between picture-frames indicate prediction directions. Horizontal arrows indicate disparity estimation, and vertical arrows indicate motion estimation. According to an exemplary embodiment of the present invention, there are three types of B pictures, which will now be described with reference to FIG. 7.

FIGS. 7A through 7F illustrate three types of B pictures used in multiview video encoding according to an exemplary embodiment of the present invention.

According to exemplary embodiments of the present embodiment, there are three types of B pictures: B, B1, and B2 pictures. In FIG. 7, the B, B1, and B2 pictures denote picture-frames predicted using two or more horizontally or vertically adjacent frames.

B pictures are predicted using two horizontally adjacent frames as illustrated in FIG. 7A, two vertically adjacent frames as-illustrated in FIG. 7B, or a horizontally adjacent frame and a vertically adjacent frame as illustrated in FIG. 7C.

B1 pictures are predicted using two horizontally adjacent frames and one vertically adjacent frame as illustrated in FIG. 7D or a horizontally adjacent frame and two vertically adjacent frames as illustrated in FIG. 7E. B2 pictures are predicted using four horizontally or vertically adjacent frames as illustrated in FIG. 7F.

The unit encoding structure indicating a prediction sequence of a multiview video according to an exemplary embodiment of the present invention will now be described with reference to FIG. 6. Referring to FIG. 6, a basic prediction sequence is I, P, B, B1 and B2 pictures in order.

First, an I frame 601 is intra-predicted. A P frame 603 is predicted by referring to the I frame 601, and a P frame 610 is predicted by referring to the I frame 601.

A B frame 602 is predicted using the I frame 601 and the P frame 603 horizontally adjacent to the B frame 602. A B frame 604 and a B frame 607 are predicted using the I frame 601 and the P frame 610 vertically adjacent to the B frame 604 and the B frame 607. A B frame 612 is predicted using the P frame 610 horizontally adjacent to the B frame 612 and the P frame 603 vertically adjacent to the B frame 612.

Then, B1 frames are predicted. Specifically, a B1 frame 606 is predicted using the B frame 604 horizontally adjacent to the B1 frame 606 and the P frame 603 and the B frame 612 vertically adjacent to the B1 frame 606. A B1 frame 609 is predicted using the B frame 607 horizontally adjacent to the B1 frame 609 and the P frame 603 and the B frame 612 vertically adjacent to the B1 frame 609. A B1 frame 611 is predicted using the P frame 610 and the B frame 612 horizontally adjacent to the B1 frame 611 and the B frame 602 vertically adjacent to the B1 frame 611.

Finally, B2 frames are predicted. Specifically, a B2 frame 605 is predicted using the B frame 604 and the B1 frame 606 horizontally adjacent to the B2 frame 605 and the B frame 602 and the B1 frame 611 vertically adjacent to the B2 frame 605. In addition, a B2 frame 608 is predicted using the B frame 607 and the B1 frame 609 horizontally adjacent to the B2 frame 608 and the B frame 602 and the B1 frame 611 vertically adjacent to the B2 frame 608.

As described above with reference to FIGS. 6 and 7A through 7F, according to exemplary embodiments of the present invention, bi-directional prediction is performed with reference not only to B frames, but also to B1 and B2 frames. Since the number of B type frames can be increased, the amount of information required for encoding a multiview image can be minimized. Therefore, according to an exemplary embodiment of the present invention, to efficiently encode a multiview image, B frames are grouped according to the types of frame illustrated in FIGS. 7A through 7F and encoded in the prediction sequence B frame→B1 frame→B2 frame as described above.

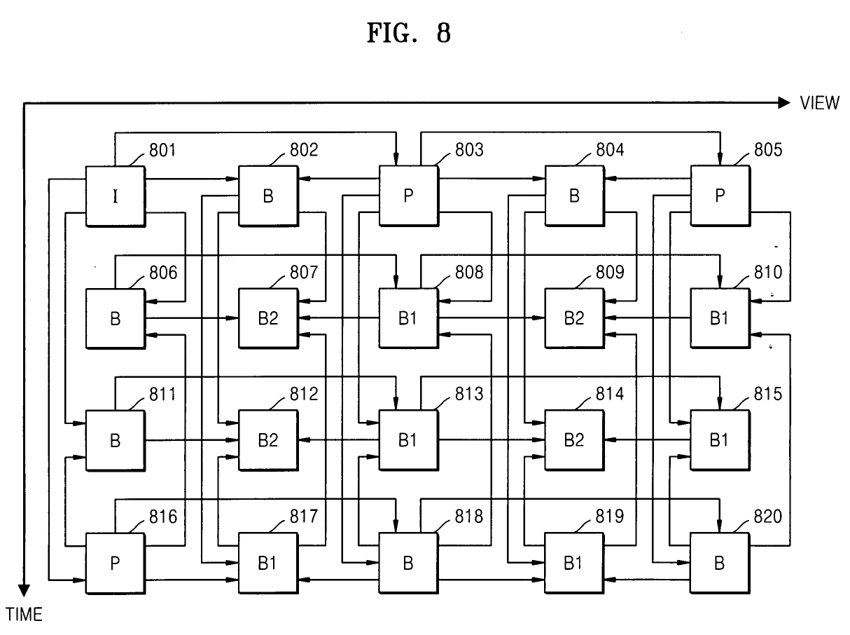

FIG. 8 illustrates a horizontally extended unit encoding structure of a multiview video according to an exemplary embodiment of the present invention. FIG. 8 illustrates a prediction block structure which has a 5-view of an input image source.

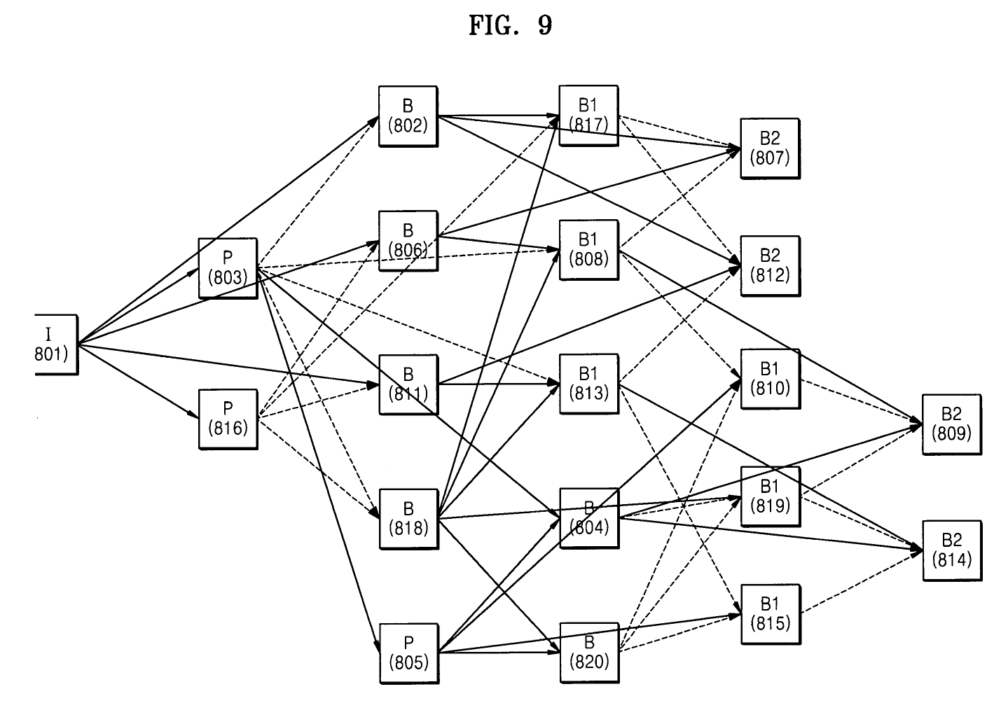

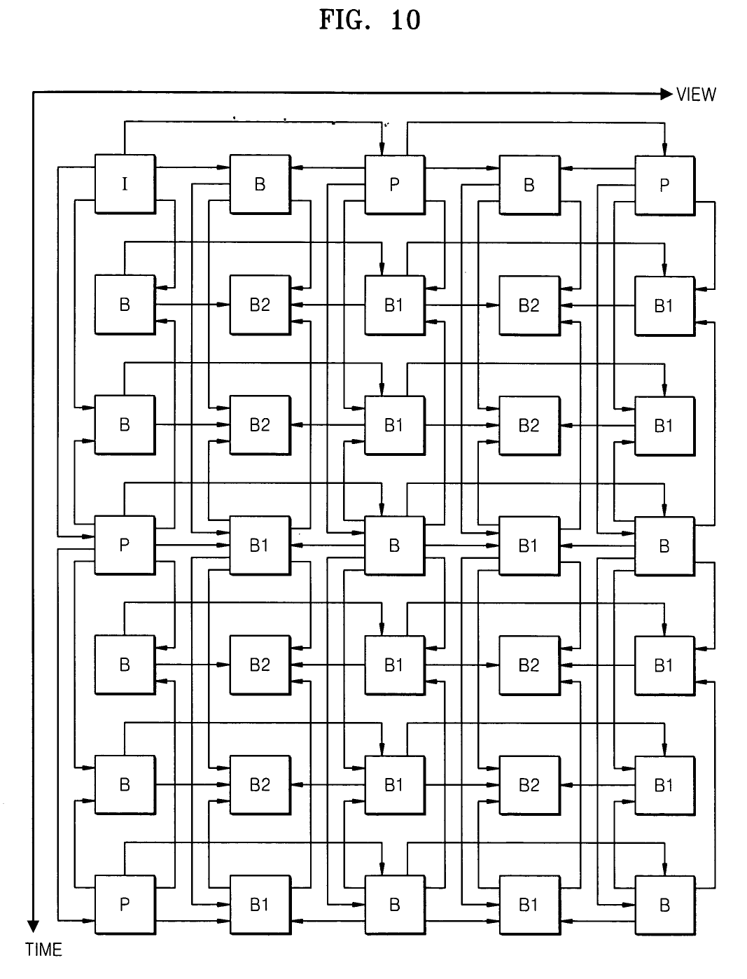

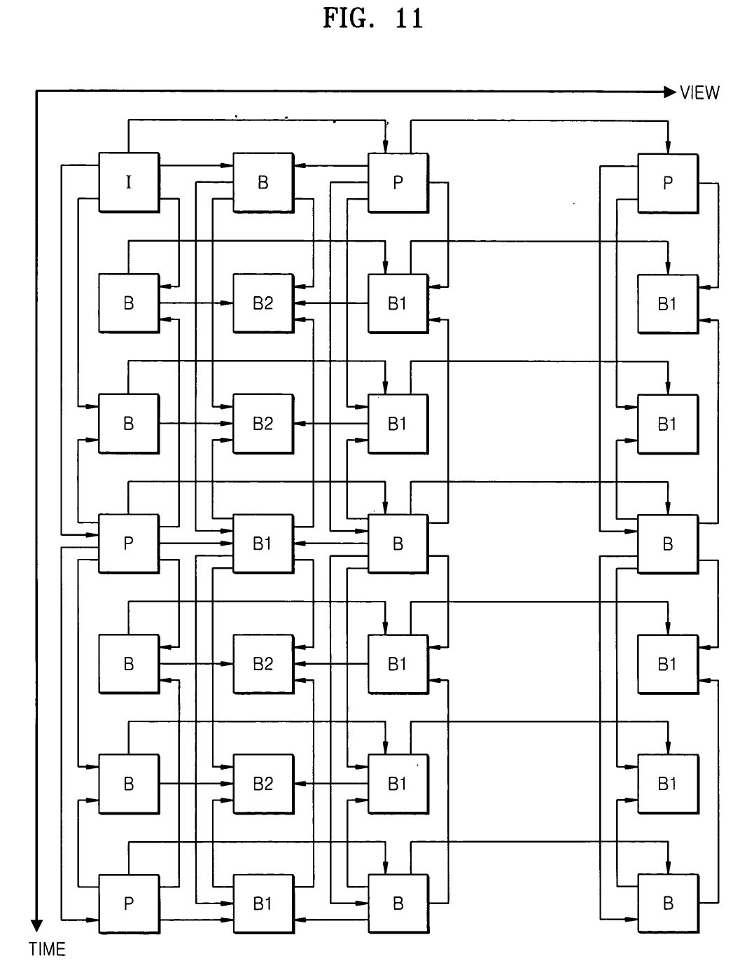

FIG. 9 illustrates a prediction sequence of the multiview image of FIG. 8. In FIG. 9, frames in the same column are predicted at the same time. Referring to FIG. 9, first, an I frame 801 is intra-predicted. Then, a P frame 803 and a P frame 816 in a second column are predicted, and B frames 802, 806, 811 and 818 and a P frame 805 in a third column are predicted. Next, B1 frames 817, 808 and 813, and B frames 804 and 820 are predicted. B2 frames 807 and 821 and B1 frames 810, 819 and 815 in a fifth column are then predicted. Finally, B2 frames 809 and 814 are predicted. Therefore, the prediction sequence according to the present exemplary embodiment is I, P, B, B1, B2, P, B, B1 and B2 pictures in order.

FIG. 10 illustrates a video encoding structure having an odd number of views for motion estimation and disparity estimation according to an exemplary embodiment of the present invention.

FIG. 11 illustrates a video encoding structure having an even number of views for motion estimation and disparity estimation according to an exemplary embodiment of the present invention.

The video encoding structure of FIG. 11 can be obtained by disabling a fourth column of prediction frames in the five-view video encoding structure of FIG. 10. The video encoding structure according to the present exemplary embodiment can be horizontally and vertically extended.

Therefore, according to an exemplary embodiment of the present invention, an n-view (n is an odd number) video encoding structure can be reconfigured into an (n-1)-view video encoding structure by disabling an (n-1)^{th} column of prediction frames.

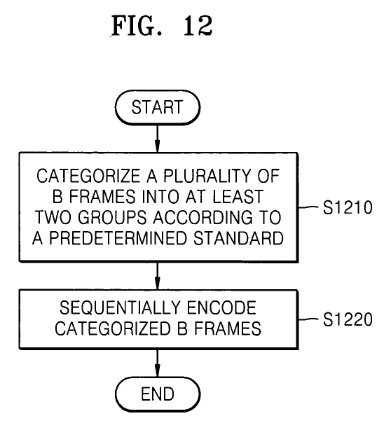

FIG. 12 is a flowchart illustrating a method of encoding a multiview video according to an exemplary embodiment of the present invention. The method has been described with reference to FIGS. 6 through 11. In particular, B frames are encoded in the method as follows.

A plurality of B frames are divided into at least two groups according to a predetermined standard (S 1210). The predetermined standard may be the number of frames that each B frame refers to or may be the number of frames that each B frame refers to and the position of the reference frames.

The B frames may be categorized into a first group of B frames which are predicted with reference to two horizontally adjacent frames, two vertically adjacent frames or one horizontally adjacent frame and one vertically adjacent frame, a second group of B frames which are predicted with reference to two horizontally adjacent frames and one vertically adjacent frame or one horizontally adjacent frame and two vertically adjacent frames, and a third group of B frames which are predicted with reference to two horizontally adjacent frames and two vertically adjacent frames.

The B frames grouped as described above are sequentially encoded (S 1220). In this case, the B frames may be encoded in the order of the first group, the second group, and the third group.

As described above, the present invention provides a method and apparatus for efficiently encoding a multiview video to simultaneously provide the multiview video which is realistic to many people.

The present invention also provides a method and apparatus for encoding a multiview video using a B-frame prediction structure that uses a minimum amount of information regarding the multiview video.

The present invention can also be implemented as computer-readable code on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves (such as data transmission through the Internet).

The computer-readable recording medium can also be distributed over network-coupled computer systems so that the computer-readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of encoding a multiview video, the method comprising:
categorizing a plurality of B frames into at least two groups according to a predetermined standard; and
sequentially encoding the categorized plurality of B frames.

2. The method of claim 1, wherein the predetermined standard comprises a number of frames to which each of the plurality of B frames refers.

3. The method of claim 1, wherein the predetermined standard comprises a number of frames to which each of the plurality of B frames refers and view positions of the frames.

4. The method of claim 1,
wherein the plurality of B frames are categorized into a first group of B frames which are predicted with reference to two horizontally adjacent frames, two vertically adjacent frames or one horizontally adjacent frame and one vertically adjacent frame, a second group of B frames which are predicted with reference to two horizontally adjacent frames and one vertically adjacent frame or one horizontally adjacent frame and two vertically adjacent frames, and a third group of B frames which are predicted with reference to two horizontally adjacent frames and two vertically adjacent frames, and
wherein the one or two horizontally adjacent frames are a frame or frames obtained from the multiview video at a same temporal level as a B frame of the first group, the second group or the third group, and the one or two vertically adjacent frames are a frame or frames obtained from the multiview video at a same view position as the B frame of the first group, the second group or the third group.

5. The method of claim 4, wherein the sequential encoding of the categorized plurality of B frames comprises sequentially encoding the first group of B frames, the second group of B frames, and the third group of B frames.

6. The method of claim 1,
wherein the sequential encoding is performed based on a video encoding structure comprising the plurality of B frames,
wherein the sequential encoding comprises performing disparity estimation between frames disposed horizontally according to a plurality of views and performing motion estimation between frames disposed vertically according to passage of time,
wherein the video encoding structure is extendible at least one of horizontal and vertical directions, and
wherein the frames disposed horizontally are frames obtained from the multiview video at a same temporal level, and the frames disposed vertically are frames obtained from the multiview video at a same view position.

7. The method of claim 6, wherein the plurality of views comprises n views, where n is an odd natural number.

8. The method of claim 7, wherein frames obtained at an (n-1)th view are not used for the disparity estimation and the motion estimation.

9. The method of claim 7, wherein, in the video encoding structure, frames obtained at views except a first view, among the plurality of views, do not include an I frame, and frames obtained at a k-th view comprises only B frames, where k is an even natural number which is smaller than n.

10. An apparatus for encoding a multiview video, the apparatus comprising:
a prediction unit which predicts a disparity vector and a motion vector of an input multiview video;
a disparity and motion compensation unit which compensates an image using the disparity vector and the motion vector;
a residual image encoding unit which receives the input multiview video and the compensated image generated by the disparity and motion compensation unit, subtracts the compensated image from the original image, and encodes a residual image obtained from the subtraction; and
an entropy-encoding unit which generates a bit stream for the multiview video using the disparity vector, the motion vector, and the encoded residual image,
wherein the prediction unit categorizes a plurality of B frames into at least two groups according to a predetermined standard and sequentially predicts the categorized plurality of B frames.

11. The apparatus of claim 10, wherein the predetermined standard comprises a number of frames to which each of the plurality of B frames refers.

12. The apparatus of claim 10, wherein the predetermined standard comprises a number of frames to which each of the plurality of B frames refers and view positions of the frames.

13. The apparatus of claim 10, wherein the plurality of B frames are categorized into a first group of B frames which are predicted with reference to two horizontally adjacent frames, two vertically adjacent frames or one horizontally adjacent frame and one vertically adjacent frame, a second group of B frames which are predicted with reference to two horizontally adjacent frames and one vertically adjacent frame or one horizontally adjacent frame and two vertically adjacent frames, and a third group of B frames which are predicted with reference to two horizontally adjacent frames and two vertically adjacent frames,
wherein the one or two horizontally adjacent frames are a frame or frames obtained from the multiview video at a same temporal level as a B frame of the first group, the second group or the third group, and the one or two vertically adjacent frames are a frame or frames obtained from the multiview video at a same view position as the B frame of the first group, the second group or the third group.

14. The apparatus of claim 13, wherein the prediction unit sequentially predicts the first group of B frames, the second group of B frames, and the third group of B frames.

15. The apparatus of claim 10,
wherein the prediction unit predicts the disparity vector and the motion vector of an input multiview video based on a video encoding structure comprising the plurality of B frames,
wherein the prediction unit further performs disparity estimation between frames disposed horizontally according to a plurality of views and performs motion estimation between frames disposed vertically according to passage of time,
wherein the video encoding structure is extendible at least one of horizontal and vertical directions, and
wherein the frames disposed horizontally are frames obtained from the multiview video at a same temporal level, and the frames disposed vertically are frames obtained from the multiview video at a same view position.

16. The apparatus of claim 15, wherein the plurality of views comprises n views, where n is an odd natural number.

17. The apparatus of claim 16, wherein frames obtained at an (n-1)th view are not used for the disparity estimation and the motion estimation.

18. The apparatus of claim 16, wherein, in the video encoding structure, frames obtained at views except a first view, among the plurality of views, do not include an I frame, and frames obtained at a k-th view comprises only B frames, where k is an even natural number which is smaller than n.

19. A computer-readable recording medium storing a method of encoding a multiview video, the method comprising:
categorizing a plurality of B frames into at least two groups according to a predetermined standard; and
sequentially encoding the categorized plurality of B frames.

20. The computer-readable recording medium of claim 19, wherein the predetermined standard comprises a number of frames to which each of the plurality of B frames refers.

21. The computer-readable recording medium of claim 19, wherein the predetermined standard comprises a number of frames to which each of the plurality of B frames refers and view positions of the frames.

22. The computer-readable recording medium of claim 19,
wherein the plurality of B frames are categorized into a first group of B frames which are predicted with reference to two horizontally adjacent frames, two vertically adjacent frames or one horizontally adjacent frame and one vertically adjacent frame, a second group of B frames which are predicted with reference to two horizontally adjacent frames and one vertically adjacent frame or one horizontally adjacent frame and two vertically adjacent frames, and a third group of B frames which are predicted with reference to two horizontally adjacent frames and two vertically adjacent frames, and
wherein the one or two horizontally adjacent frames are a frame or frames obtained from the multiview video at a same temporal level as a B frame of the first group, the second group or the third group, and the one or two vertically adjacent frames are a frame or frames obtained from the multiview video at a same view position as the B frame of the first group, the second group or the third group.

23. The computer-readable recording medium of claim 22, wherein the sequential encoding of the categorized plurality of B frames comprises sequentially encoding the first group of B frames, the second group of B frames, and the third group of B frames.

24. The computer-readable recording medium of claim 19, wherein the sequential encoding is performed based on a video encoding structure comprising the plurality of B frames,
wherein the sequential encoding comprises performing disparity estimation between frames disposed horizontally according to a plurality of views and performing motion estimation between frames disposed vertically according to passage of time,
wherein the video encoding structure is extendible at least one of horizontal and vertical directions, and
wherein the frames disposed horizontally are frames obtained from the multiview video at a same temporal level, and the frames disposed vertically are frames obtained from the multiview video at a same view position.

25. The computer-readable recording medium of claim 24, wherein the plurality of views comprises n views, where n is an odd natural number.

26. The computer-readable recording medium of claim 25, wherein frames obtained at an (n-1)th view are not used for the disparity estimation and the motion estimation.

27. The computer-readable recording medium of claim 25, wherein, in the video encoding structure, frames obtained at views except a first view, among the plurality of views, do not include an I frame, and frames obtained at a k-th view comprises only B frames, where k is an even natural number which is smaller than n.
